(19) United States
(12) Patent Application Publication
(10) Pub. No.: US 2008/0101569 A1
(43) Pub. Date: May 1, 2008

(54) PREPAID INFORMATION SERVICES

(75) Inventor: John Decker, Decatur, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/553,451

(22) Filed: Oct. 26, 2006

(51) Int. Cl. H04M 15/00

(52) U.S. Cl. 379/114.2

(57) ABSTRACT

A prepaid information services card is provided for use in both wireline and wireless communications networks without the cardholder having to be a subscriber to a telecommunications service provider. The prepaid information services card may be used to access directory assistance and enhanced directory assistance information services such as weather information, traffic information, and stock information. A communications platform processes information service requests from cardholders, determines an appropriate information system for fulfilling the request, and communicates the results back to a user communication device associated with the cardholders The results may be communicated to one or more user communication devices in a number of output formats including text, audio, and video. Card usage statistics may be tracked and a facility provided for replenishing the prepaid card when a predetermined number of units falls below a threshold.

### BACKGROUND

Subscribers of landline (i.e., wireline) and wireless telephone systems frequently dial “411” to access directory assistance. Using traditional wireline 411, a telephone subscriber may obtain, for a fixed fee or tariff per use, telephone directory information including a name, a telephone number, and an address. Traditional wireline 411, however, is limited to only providing standard directory assistance (i.e., name, address, and telephone number) by the Federal Communications Commission.

As a result of the limitations of traditional wireline 411 and in order to provide subscribers with additional features, many wireline and wireless telecommunications providers also offer enhanced directory assistance (“EDA”) which includes information services that may be accessed by calling a special toll or toll-free telephone number. Subscribers may utilize EDA to access a number of “concierge” services such as local weather and traffic information, movie listings, stock quotes, and the like. Typically, a user must be a subscriber or a registered user of the telecommunications provider to access EDA information services. These EDA type services may be fee-based in which the subscriber is charged a fixed or variable fee per use or advertiser supported in which a fee is not charged but the subscriber must listen to one or more advertisements by a sponsoring company in order to use the service.

Current wireline and wireless EDA services, however, suffer from several drawbacks. As a result of the deregulation of the telephone industry, a single Local Access and Transport Area (“LATA”) may be served by several telecommunications provider offering local and/or long distance service. Thus, one drawback is that since many wireline EDA services require an account with a particular telecommunications provider, a user may not have access to subscriber-based EDA services if he or she is not near a home telephone or other subscriber location. EDA services provided by wireless telecommunications providers, while not location dependent, also require subscriber access for use. In addition, wireless EDA services are typically offered at an additional fixed cost per use in addition to a wireless service plan which may cause many subscribers to limit the use of these services for cost reasons. It is with respect to these considerations and others that the various embodiments of the present invention have been made.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments solve the above and other problems by providing a prepaid information services card which may be purchased for use in both wireline and wireless communications networks. The cardholder can be a subscriber to any telecommunications service provider. The prepaid information services card may be used to access directory assistance and enhanced directory assistance information services such as weather information, traffic information, and stock information. A communications platform processes information service requests from cardholders, determines an appropriate information system for fulfilling the request, and communicates the results back to a user communication device associated with the cardholders The results may be communicated to one or more user communication devices in a number of output formats including text, audio, and video. The communications platform may also track card usage statistics and provide a facility for replenishing the prepaid card when a predetermined number of units falls below a threshold.

According to one exemplary embodiment, a user access code is received from a prepaid card for accessing the information services over a communications network. After receiving the user access code, a menu of information services may be provided to the user. An information request directed to a selected information service may be received. Based on the request, an information system associated with the selected information service is determined. A search query is formatted containing the information request and sent to the information system. The requested information is received from the information system and formatted for transmission to a user communication device.

These and various other features, as well as advantages, which characterize the various embodiments, will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a network diagram illustrating aspects of a combined wireline and wireless communications network utilized in and provided by various embodiments;

FIG. 2 is a flow diagram illustrating aspects of a process for providing and accessing prepaid information services in the communications network of FIG. 1, in accordance with various embodiments; and

FIG. 3 is a flow diagram illustrating aspects of a process for tracking usage and replenishing a prepaid information services card, in accordance with various embodiments.

### DETAILED DESCRIPTION

As briefly described above, various embodiments are directed to providing and accessing prepaid information services. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

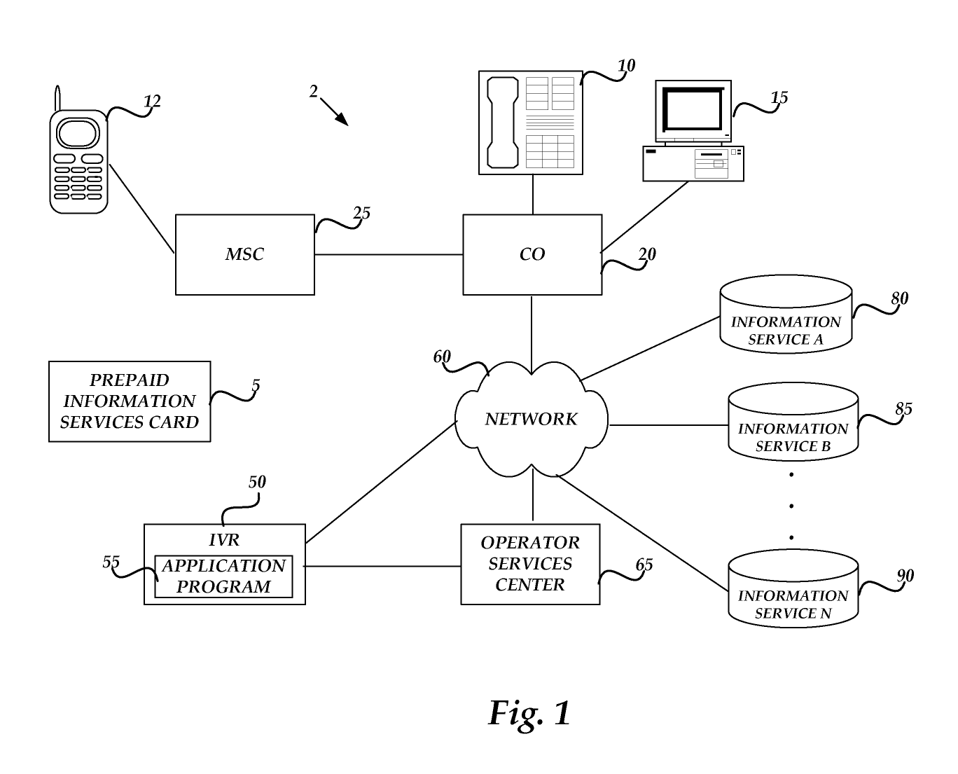

Referring now to the drawings, in which like numerals represent like elements through the several figures, various aspects of the present invention and an illustrative network environment will be described. In particular, FIG. 1 and the corresponding discussion are intended to provide a brief, general description of a suitable network environment in which the invention may be implemented.

Embodiments of the invention may be implemented as a computer process (method), a computing system, or as an article of manufacture, such as a computer program product or computer-readable media. The computer program product may be a computer storage media readable by a computer system and encoding a computer program of instructions for executing a computer process. The computer program may also be a propagated signal on a carrier readable by a computing system and encoding a computer program of instructions for executing a computer process.

Various embodiments may be generally employed in a communications network 2 as shown in FIG. 1. The communications network 2 may include various user communication devices for conducting voice and data communications. The user communication devices may include a standard wireline telephone set 10, which is connected via a subscriber line to a central office 20. According to illustrative embodiments of the invention, the central office 20 may be a standard central office circuit switch or a softswitch for routing voice and data traffic. The user communication devices may also include a wireless telephone 12 which is in wireless communication with a mobile switching center (“MSC”) 25. The MSC 25 may be utilized to communicate wireless voice traffic from the wireless telephone 12 to the central office 20 via a wireline connection. The user communication devices may also include a personal computer 15 in communication with the central office 20 for sending and receiving data, such as electronic mail (“e-mail”) over a network 60. It should be appreciated that the network 60 may include any type of computing network, including a local area network or a wide area network, such as the Internet.

In one embodiment, the wireless telephone 12 may include functionality for sending and receiving data messages over the network 60 via communication over one or more wireless data gateways (not shown) in communication with the network 60. The data messages may include, but are not limited to e-mail messages, short message service (“SMS”) messages, text messages, or any other message types known to those skilled in the art which may be communicated in a communications network. It should be understood by those skilled in the art that the central office 20, the MSC 25 and the connections between them and the user communication devices 10, 12, and 15 may be components in a typical public switched telephone network (“PSTN”). Those skilled in the art will appreciate that, in accordance with other embodiments, the communications network 2 may include other user communication devices in addition to or instead of the wireline telephone set 10, the wireless telephone 12, and the personal computer 15, described above. These user communication devices may include, but are not limited to two-way paging devices, voice over Internet protocol (“VOIP”) or Internet telephones, microprocessor-based or programmable consumer electronics, minicomputers, mainframe computers, and the like.

In accordance with one embodiment, and as will be described in greater detail below, the user communication devices 10, 12, and 15 may be utilized to access prepaid information services utilizing a prepaid services card 5. The prepaid card 5 may be a telephone calling card which is marketed in various predetermined dollar amounts, minutes, or units (e.g., one unit may be equal to one telephone call) through various outlets such as retail and pharmacy chains, discount shopping clubs, convenience stores, gas stations, vending machines, mail order, commercial Internet sites, and the like. The prepaid card 5 may be utilized for accessing various information services including directory assistance (“DA”) and enhanced directory assistance (“EDA”) services. DA services include name, address and telephone number information for a local or national region. EDA services, on the other hand, may include a wide variety of information services including, but not limited to, sports scores, weather information, movie listings, stock quotes, mapping services (including driving directions), traffic reports, Internet searching, a “find nearest” service (e.g., used for finding nearby establishments such as coffee shops, hardware stores, automatic teller machines, etc.), yellow pages searches, international directory assistance, and directory assistance which support the use of one or more foreign languages. In addition, EDA services may include advanced directory services. An advanced directory service may include a facility for receiving categorical and sub-categorical data related to a desired listing including a communications address. Other embodiments include receiving sub-categorical data. Search requests may then be initiated for the desired listing associated with the received categorical and/or sub-categorical data. For instance, a user looking for specific gym equipment may utilize advanced directory services to locate nearby business by submitting the category “gym” and sub-category “equipment” to the service which may then search for local advertiser listings. Advanced directory services are described in greater detail in U.S. patent application Ser. No. 11/470,125, entitled “Advanced Directory Services,” the disclosure of which is incorporated herein by reference in its entirety.

The prepaid card 5 may be activated by calling an activation number thus enabling a user to access the information services upon entering an access code such as a personal identification number (“PIN”). In one embodiment, the prepaid card 5 may be rechargeable once the number of pre-assigned dollars, minutes, or units has expired. The prepaid card 5 may also include a specific number of minutes of calling time for completing telephone calls (including long distance calls) to telephone numbers returned by an information service (if the information service supports this feature). It will be appreciated that the prepaid card 5 may be competitively priced so that it is lower than a tariff rate for Directory Assistance and/or other information services.

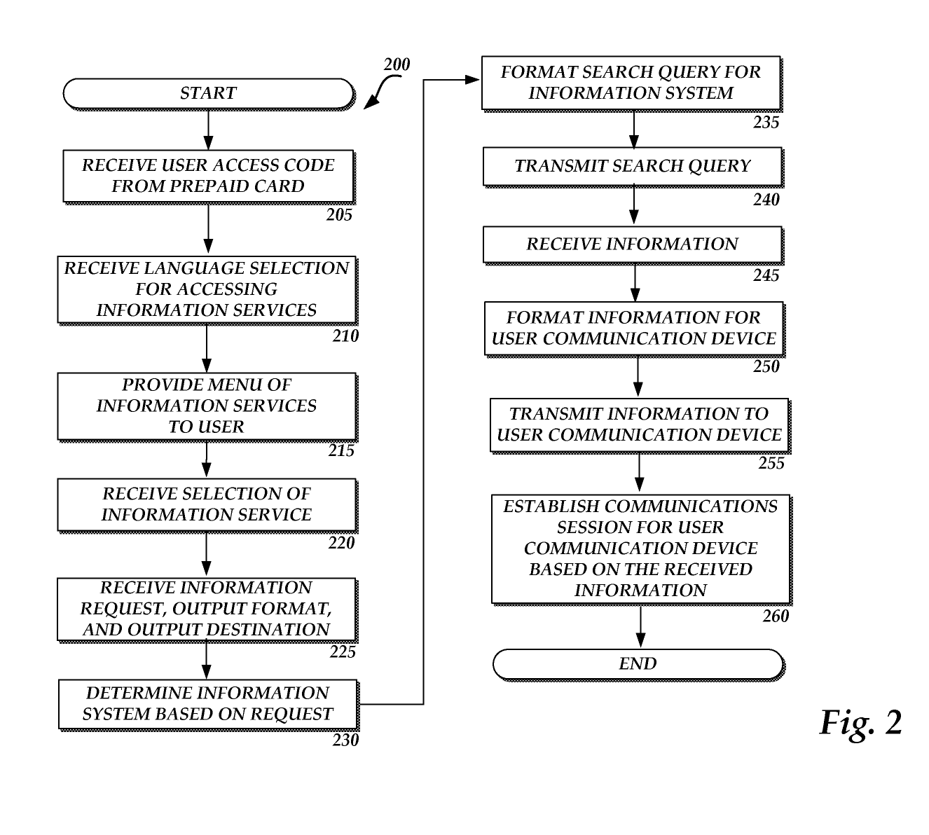

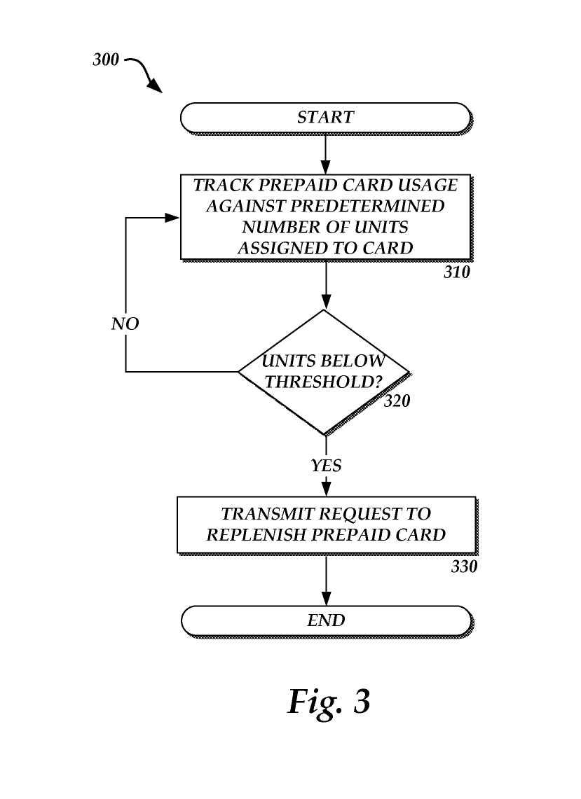

The communications network 2 also includes a communications platform which may be an interactive voice response computer system (“IVR”) 50. The IVR 50 is in communication with the user communication devices 10, 12, and 15 through the central office 20 and the MSC 25, the network 60, an operator services center 65, and a number of information systems (i.e., databases) 80, 85, and 90. As known to those skilled in the art, an IVR system is an automated computer telephony system which interacts with callers, gathers information, and routes calls to the appropriate recipient. An IVR system accepts a combination of voice telephone input and touch-tone keypad selection and may provide appropriate responses in the form of voice, fax, callback, e-mail and other media. The IVR system 50 may also be operative to execute software application program 55, residing therein. The application program 55 may provide pre-recorded voice responses, keypad signal logic, and access to the information systems 80, 85, and 90. The application program 55 may also cause the IVR 50 to “handoff” a received call to a human operator at the operator services center 65. In accordance with one embodiment, the application program 55 may utilize voice prompts and responses to receive and process information service requests from users of the prepaid card 5. In particular, formatted user information requests may be routed to the information systems 80, 85, and 90 or to the network 60 (e.g., for Internet searches) and the results forwarded to the requesting user communication devices or to a secondary user communication device designated by the user. The format of the results themselves may also be designated by the user such that a user of the prepaid card 5 may receive information as an audio message, a text message (e.g., an SMS message or an e-mail message), or a video message (i.e., if a designated user communication device supports video). The functionality of the IVR 50 and the application program 55 will be discussed in greater detail below with respect to FIGS. 2 and 3.

In one embodiment, the information systems 80, 85, and 90 may be databases for storing information related to DA and EDA services. For instance, an information system may include a dedicated database for storing updated movie listings. It should be understood that while the information systems described herein are shown as multiple databases, in other embodiments, they may be incorporated into a single database in communication with the IVR 50 or as single or multiple databases within the IVR 50.

Referring now to FIG. 2, an illustrative routine 200 will be described illustrating a process that may be performed by the application program 55 resident on the IVR 50 for providing and accessing prepaid information services in the communications network 2, discussed above. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIGS. 2 and 3, and making up the embodiments described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

The routine 200 begins at operation 205, where the application program 55 receives a user access code from the prepaid card 5. In particular, a user may call the IVR 50 via a toll-free telephone number and enter a PIN assigned to the card in response to an automated voice prompt.

From operation 205, the routine 200 continues to operation 210 where the application program 55 receives a language selection for accessing information services. In particular, the application program 55 upon verifying the user access code, may generate a voice prompt to the user of the prepaid card 5 to select from a list of languages for interacting with the IVR 50 and/or the operator services center 65. It will be appreciated that the application program 55 may save a user's initial selection such that after a language selection is made, all subsequent interaction with the user of the prepaid card 5, including voice prompts, voice and/or text responses, and operator services support will be made in the selected language.

From operation 210, the routine 200 continues to operation 215 where the application program 55 provides a menu of information services to the user of the prepaid card 5, including a list of DA and EDA services discussed above with respect to FIG. 1. In one embodiment, the menu may be presented to the user as a series of voice prompts communicated to a user communication device via the IVR 50.

From operation 215, the routine 200 continues to operation 220 where the application program 55 receives a selection of an information service from the menu by the user of the prepaid card 5 via a user communication device. For instance, the user of the prepaid card 5 may make a selection by inputting a keypad number corresponding to a menu selection from the user communication devices 10, 12, or 15, or by verbally making a selection to the IVR 50 (e.g., “Sports Scores”).

From operation 220, the routine 200 continues to operation 225 where the application program 55 receives an information request for the information service selected by the user of the prepaid card 5. The information request may include a designation of a user communication device for receiving the results and an output format (e.g., audio, e-mail, SMS message, video, etc.). For instance, a user accessing the IVR 50 from the wireline telephone 10 may select stock quotes from the information service menu, request information pertaining to a particular stock or group of stocks (e.g., by stock name or symbol) and designate that the results be sent to the personal computer 15 as an e-mail message for subsequent review. It will be appreciated that in this manner a user requesting information from an information service does not have to remain on the telephone (and use additional prepaid card minutes while doing so) to receive and review the results of the request. Instead, the user may designate the results to be received offline at one or more communication devices other than the communication device used to access prepaid information services and request a particular information service.

From operation 225, the routine 200 continues to operation 230 where the application program 55 determines an appropriate information system to forward the request based on the received information request. In particular, the application program 55 may include logic for determining which of the information systems or databases 80, 85, or 90 to send a particular request. For instance, if a user of the prepaid card 5 previously requested college football score information, the application program 55 may automatically route the user request to a database containing college football scores. It should be understood that the determination of the information system may be automatically performed by the application program 55 or manually performed by an operator in the operator services center 65. In particular, in accordance with one embodiment, the application program 55 upon receiving an information request, may route the information request to a live operator who would then determine an appropriate system for fulfilling the request. For instance, an operator may be utilized to fulfill a request for local directory assistance. It should further be understood that the application program 55 may automatically determine the appropriate information service to send a particular request dynamically. That is, the application program 55 may determine the appropriate information system (e.g., database or Internet website) based on key words in an information request directed to a general information service category such as an Internet search. For instance, the application program 55, in response to a user requesting information about headaches, may determine a medical search engine website, such as the medical search engine website provided by WEBMD® of New York, N.Y., as the appropriate service for fulfilling the user request. It will be appreciated that the application program 55 may include or have access to a library of keywords and a list of associated information systems which may be compared to various user requests to determine an appropriate information system.

From operation 230, the routine 200 continues to operation 235 where the application program 55 formats a search query containing the user requested information for the information system determined at operation 230. In particular, the application program 55 may be configured to format search queries according to a specified format required by a particular information system (e.g., Boolean).

From operation 235, the routine 200 continues to operation 240 where the application program 55 instructs the IVR 50 to transmit the search query to an information system determined to be appropriate for the user request. From operation 240, the routine continues to operation 245 where the application program 55 receives the requested information from the information system.

From operation 245, the routine 200 continues to operation 250 where the application program 55 formats the received information according to an output designated by the user at operation 225. For instance, the application program 55 may generate an e-mail message containing the received information to be sent from the IVR 50 via an e-mail server (not shown) to the personal computer 15 over the network 60.

From operation 250, the routine 200 continues to operation 255 where the application program 55 instructs the IVR 50 to transmit the received information to a previously designated user communication device, or if no designation was made, to the requesting user communication device. The information may be transmitted in a format previously specified by a user, or if no format is specified, an audio message containing the results may be generated and transmitted to the requesting user communication device.

From operation 255, the routine 200 continues to operation 260 where the application program 55 may instruct the IVR 50 to establish a communications session for the user communication device based on the information received in response to the user's information request. In particular, a communications session may be established in response to information requests for directory assistance searches, “find nearest” searches (e.g., coffee shops, hardware stores, automatic teller machines, etc.), yellow pages searches, and advanced directory service searches in which a telephone number may be returned as a result. In these instances, it will be appreciated that the application program 55 may be configured to instruct the IVR 50 to automatically connect the requesting user's communication device to a telephone number contained in the search query results which may relieve the user of the need to make another telephone call. As briefly discussed above with respect to FIG. 1, in accordance with one embodiment, the prepaid card 5 may include a predetermined number of additional minutes or units of calling time for this option. The routine 200 then ends.

Referring now to FIG. 3, an illustrative routine 300 will be described illustrating a process that may be performed by the application program 55 resident on the IVR 50 for tracking usage and replenishing a prepaid information services card, in accordance with various embodiments.

The routine 300 begins at operation 310, where the application program 55 tracks the usage of the prepaid card 5 against a predetermined number of units assigned to the card. As briefly discussed above with respect to FIG. 1, in accordance with one embodiment, the prepaid card 5 may include a predetermined number of units (where a unit is equivalent to a single call) for accessing information services. In accordance with other embodiments, the prepaid card 5 may optionally include a predetermined number of minutes or a predetermined currency amount (e.g., five dollars, ten dollars, or twenty-five dollars) for accessing the information services. In various embodiments, the application program 55 may be configured to track the usage of the prepaid card (i.e., on a per use or per unit basis, an elapsed time basis, or a used currency basis) and generate a replenishment request for the user when the balance of the prepaid card 5 falls below a threshold. It will be appreciated the threshold amount may be determined at the time the prepaid card is activated or alternatively by the prepaid card provider. It will further be appreciated that in an alternative embodiment, the application program 55, in tracking the usage of the prepaid card 5, may be configured to generate a free usage offer once a predetermined usage threshold has been exceeded, as determined by the prepaid card provider. For instance, for every five units used for prepaid information services, the sixth unit is free.

From operation 310, the routine 300 continues to operation 320 where the application program 55 determines if the number of units remaining (or minutes, or currency balance) is below the threshold. If, at operation 320, the application program 55 determines that the number of units is not below the threshold, then the routine 300 returns to operation 310. If however, at operation 320, the application program 55 determines that the number of units is below the threshold, then the routine 300 continues to operation 330 where the application program 55 generates a request to replenish the prepaid card 5 and instructs the IVR 50 to transmit the replenishment request to the requesting user communication device. Upon receiving a replenishment request, the user would have the option of adding more money to the prepaid card 5 in a manner known to those skilled in the art or discard it. The routine 300 then ends.

Based on the foregoing, it should be appreciated that various embodiments are directed to providing and accessing prepaid information services. It will be apparent by those skilled in the art that various modifications or variations may be made in the present invention without departing from the scope or spirit of the invention. Other embodiments will be apparent to those skilled in the art from consideration of the specification and practice of the invention disclosed herein.

What is claimed is:

1. A method for accessing a plurality of information services in a communications network, comprising:
receiving a user access code from a prepaid card for accessing the plurality of information services over the communications network;
receiving an information request directed to an information service selected from among the plurality of information services;
determining, based on the request, an information system associated with the selected information service for retrieving the requested information;
formatting a search query containing the information request to send to the information system, wherein the search query is formatted to be compatible with the information system; and
receiving the requested information from the information system.

2. The method of claim 1 further comprising:
providing a menu of information services to the user;
transmitting the search query to the information system;
formatting the requested information for a user communication device; and
transmitting the requested information to the user communication device.

3. The method of claim 2, wherein formatting the requested information for a user communication device comprises formatting the requested information for a second user communication device which is different from a first communication device from which the user access code is received.

4. The method of claim 2, wherein formatting the requested information for a user communication device comprises formatting the requested information as at least one of an audio message, a video message, an electronic mail message, and a short message service message.

5. The method of claim 2, wherein transmitting the requested information to the user communication device comprises transmitting a telephone number.

6. The method of claim 5 further comprising automatically establishing a communications session between the user communication device and the telephone number.

7. The method of claim 1, wherein receiving a user access code from a prepaid card for accessing the plurality of information services over the communications network comprises receiving a user access code from a prepaid card over a wireline communications network.

8. The method of claim 1, wherein receiving a user access code from a prepaid card for accessing the plurality of information services over the communications network comprises receiving a user access code from a prepaid card over a wireless communications network.

9. The method of claim 1, wherein receiving a selection of an information service comprises receiving a selection of a directory assistance service.

10. The method of claim 1, wherein receiving a selection of an information service comprises receiving a selection of an enhanced directory assistance service.

11. The method of claim 1 further comprising:
tracking the use of a predetermined number of units assigned to the prepaid card for accessing the plurality of information services;
determining if the predetermined number of units falls below a threshold; and
if the predetermined number of units falls below the threshold, then transmitting a request to replenish the prepaid card.

12. The method of claim 1 further comprising receiving a language selection for accessing the plurality of information services over the communications network.

13. An apparatus for accessing a plurality of information services in a communications network, comprising:
a communications platform for communicating with a plurality of information systems for providing the plurality of information services and for communicating with at least one user communication device; and
an application program resident on the communications platform and operative to:
receive a user access code from a prepaid card for accessing the plurality of information services;
receive an information request directed to an information service selected from among the plurality of information services;
determine, based on the request, an information system associated with the selected information service for retrieving the requested information;
format a search query containing the information request to send to the information system, wherein the search query is formatted to be compatible with the information system; and
receive the requested information from the information system.

14. The apparatus of claim 13, wherein the application program resident on the communications platform is further operative to:
upon receiving the user access code, receive a language selection for accessing the plurality of information services over the communications network
provide a menu of information services to the user;
format the requested information for sending to the at least one user communication device through the communications platform; and
receive a language selection for accessing the plurality of information services over the communications network.

15. The apparatus of claim 14, wherein the requested information is formatted for a second user communication device which is different from the at least one user communication device from which the user access code is received.

16. The apparatus of claim 14, wherein the formatted requested information comprises at least one of an audio message, a video message, an electronic mail message, and a short message service message.

17. The apparatus of claim 13, wherein the information service comprises an enhanced directory assistance service.

18. The apparatus of claim 13, wherein the application program resident on the communications platform is further operative to:
track the use of a predetermined number of units assigned to the prepaid card for accessing the plurality of information services;
determine if the predetermined number of units falls below a threshold; and
if the predetermined number of units falls below the threshold, then generate a request for the at least one user communication device to replenish the prepaid card.

19. A computer-readable medium containing computer-executable instructions which, when executed by a computer, will cause the computer to perform a method for accessing a plurality of information services in a communications network, comprising:
receiving a user access code from a prepaid card for accessing the plurality of information services over the communications network;
providing a menu of information services to the user;
receiving an information request directed to an information service selected from the plurality of information services;
determining, based on the request, an information system associated with the selected information service for retrieving the requested information formatting a search query containing the information request to send to the information system, wherein the search query is formatted to be compatible with the information system;
transmitting the search query to the information system;
receiving the requested information from the information system;
formatting the requested information for a user communication device; and
transmitting the requested information to the user communication device.

20. The computer-readable medium of claim 19, wherein formatting the requested information for a user communication device comprises formatting the requested information for a second user communication device which is different from a first communication device from which the user access code is received.
